(19) United States
(12) Patent Application Publication
(10) Pub. No.: US 2026/0259077 A1
(43) Pub. Date: Sep. 3, 2026

(54) WEIGHING DEVICE

(71) Applicant: SHIMADZU CORPORATION, Kyoto (JP)

(72) Inventors: Masaki KANEDA, Kyoto-shi (JP); Isao SAWAMURA, Kyoto-shi (JP)

(73) Assignee: SHIMADZU CORPORATION, Kyoto (JP)

(21) Appl. No.: 19/545,530

(22) Filed: Feb. 20, 2026

(30) Foreign Application Priority Data
Feb. 28, 2025 (JP) 2025-032231
Dec. 10, 2025 (JP) 2025-244890

(51) Int. Cl. G01G 13/08; G01G 13/06

(52) U.S. Cl. CPC G01G 13/08; G01G 13/06

(57) ABSTRACT

A weighing device includes an electronic balance having a weighing pan, a trough-shaped or tubular powder container having a discharge part at one end, a powder container mounting part capable of detachably mounting the powder container such that the discharge part is positioned directly above the weighing pan, a vibrator mounted on the powder container mounting part for applying vibration to the discharge part of the powder container, and a control unit that acquires a weighing value from the electronic balance and controls an operation of the vibrator based on the weighing value.

### TECHNICAL FIELD

The present invention relates to a weighing device, and particularly to a weighing device having a device for supplying powder to a weighing pan of an electronic balance.

### BACKGROUND ART

When weighing a predetermined amount of powder such as a medicine, a container or weighing paper is placed on the weighing pan of an electronic balance, and after zero-point adjustment of the weighing value is performed in that state, a user drops the powder scooped up with a medicine spoon little by little onto the container or weighing paper until the weighing value reaches a predetermined value. However, due to force applied to the powder from the medicine spoon when scooping the powder, or due to agglomeration of the powder caused by the influence of static electricity or humidity, a mass of powder may fall onto the container or weighing paper at once, thereby causing the weighing value to exceed the predetermined value. If this happens, the work must be redone, which requires time and effort.

In order to avoid requiring such time and effort, conventionally, a powder supply device provided above the weighing pan of an electronic balance for supplying powder onto the weighing pan has been used (for example, see Patent Document 1). The powder supply device described in Patent Document 1 includes a powder container that is a container for accommodating powder therein and includes a discharge port which is a small hole for discharging the powder at a lower end, a shutter valve for opening and closing the discharge port, an impact imparting device for striking the powder container, and a controller for controlling the shutter valve and the impact imparting device based on an electric signal indicating a weighing value. In a state where the powder is accommodated in the powder container, when the shutter valve is opened and an impact is applied to the powder container by the impact imparting device, the movement of the powder in the powder container downward is promoted by this impact and gravity, and the powder is discharged out of the powder container from the discharge port. The discharged powder is supplied to a weighing pan located below the powder supply device. Then, when the weighing value of the powder on the weighing pan reaches a predetermined value, the controller controls the shutter valve to close and stops the application of the impact by the impact imparting device, thereby stopping the discharge of the powder. Through these operations, a predetermined amount of powder is weighed without requiring effort by the user.

### Prior Art Documents

### Patent Documents

[Patent Document 1] JP2010-518365A

### SUMMARY OF THE INVENTION

### Problems to the Solved by the Invention

When changing the type of powder to be weighed, or when it is necessary to avoid mixing powders of different manufacturing lots even if they are of the same type, it is necessary to clean the powder supply device before weighing new powder. In the powder supply device of Patent Document 1, it takes time and effort to disassemble the device before cleaning and to assemble the device after cleaning, and it also takes time and effort to remove powder remaining in a narrow space inside the small hole serving as the discharge port.

The problem to be solved by the present invention is to provide a weighing device equipped with a powder supply device capable of suppressing the effort of cleaning.

### Means for Solving the Problems

A weighing device according to the present invention made to solve the above problem comprises:

an electronic balance having a weighing pan;

a trough-shaped or tubular powder container having a discharge part at one end;

a powder container mounting part capable of detachably mounting the powder container such that the discharge part is positioned directly above the weighing pan;

a vibrator mounted on the powder container mounting part for applying vibration to the discharge part of the powder container; and

a control unit that acquires a weighing value from the electronic balance and controls an operation of the vibrator based on the weighing value.

When using the weighing device according to the present invention, first, after powder is accommodated in the powder container, the powder container is mounted on the powder container mounting part. From this state, when vibration is applied from the vibrator to the discharge part via the powder container mounting part under the control of the control unit, the powder spreads to both sides in the longitudinal direction of the powder container (accordingly, the thickness of the accumulated powder becomes thinner), and the powder spreading toward the discharge part side moves toward the discharge part. The powder moving toward the discharge part in this manner gradually drops from the discharge part onto the weighing pan arranged directly therebelow. The weighing value of the powder dropped on the weighing pan is fed back to the control unit, and the operation of the vibrator is controlled based on the weighing value.

When changing the type or manufacturing lot of the powder to be weighed, the powder container is removed from the powder container mounting part, and the inside of the powder container is cleaned. Since the powder container in the present invention is tubular or trough-shaped and one end of the tube or trough is the discharge part, there is no need to clean a narrow space such as a small hole. Further, since it is not necessary to provide a valve for opening and closing the discharge part, there is no need for the effort of removing the valve before cleaning or attaching the valve after cleaning.

### Effects of the Invention

According to the present invention, it is possible to obtain a weighing device equipped with a powder supply device capable of suppressing the effort of cleaning.

### BRIEF DESCRIPTION OF DRAWINGS

FIG. 1 is a schematic configuration diagram showing a first embodiment of a weighing device according to the present invention.

FIG. 2 is a perspective view showing the configuration of a powder container in the weighing device of the first embodiment in a state where powder is accommodated.

FIG. 3 is a diagram showing a state where powder is accommodated in the powder container of the first embodiment in another example.

FIG. 4 is a diagram showing a state where the powder container of the first embodiment containing powder is mounted on a powder container mounting part, and a post-weighing powder container is placed on a weighing pan.

FIG. 5 is a schematic configuration diagram showing a second embodiment of a weighing device according to the present invention.

FIG. 6 is a perspective view showing the configuration of a powder container in the weighing device of the second embodiment.

FIG. 7 is a schematic configuration diagram showing a third embodiment of a weighing device according to the present invention.

FIG. 8 is a perspective view of a powder container in the weighing device of the third embodiment.

FIG. 9 is a vertical cross-sectional view of a powder container mounting part and the powder container mounted on the powder container mounting part in the weighing device of the third embodiment.

FIG. 10 are Diagrams showing (a) a state when powder is accommodated in a powder container body, (b) a state where a lid is attached to the powder container body containing powder, and (c) a state where the powder container with the lid attached is mounted on the powder container mounting part.

### MODES FOR CARRYING OUT THE INVENTION

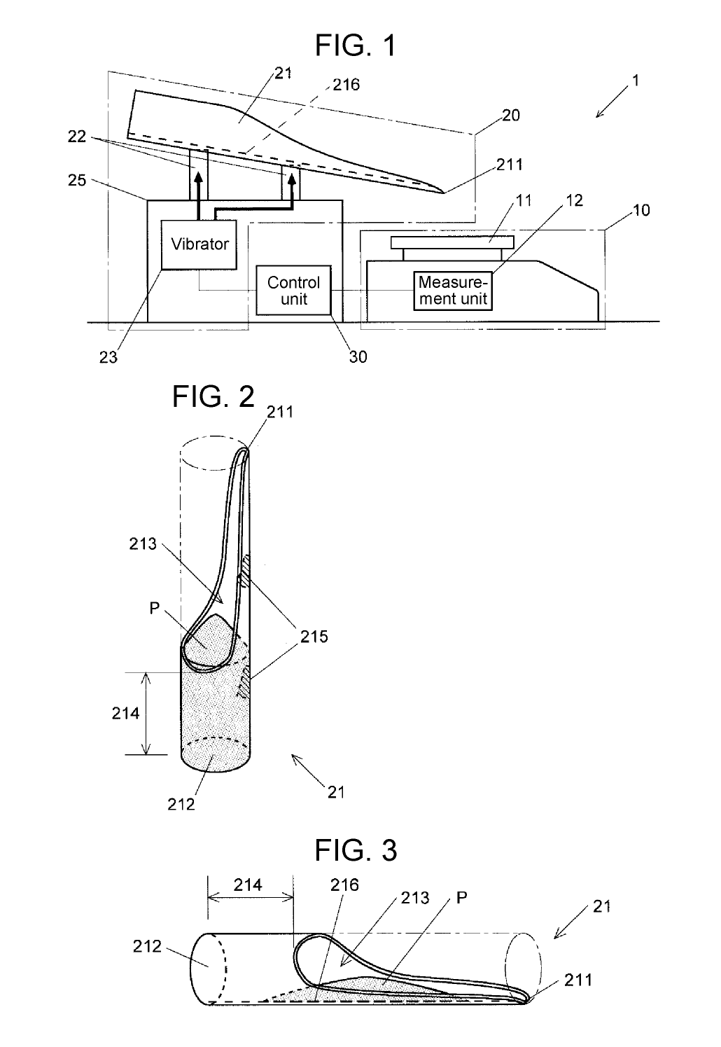

Embodiments of a weighing device according to the present invention will be described using FIGS. 1 to 10.

### First Embodiment

As shown in FIG. 1, a weighing device 1 of a first embodiment includes an electronic balance 10, a powder supply device 20, and a control unit 30.

The electronic balance 10 includes a weighing pan 11 on which an object to be measured (powder in the present invention) is placed, and a measurement unit 12. The measurement unit 12 has a function of measuring the weight of the object to be measured from the force applied to the weighing pan 11 and transmitting a weighing value signal, which is an electric signal indicating the measured value (weighing value), to the control unit 30. Since the configuration of the electronic balance 10 is the same as a conventional one, a detailed description thereof is omitted.

The powder supply device 20 includes a powder container 21, a powder container mounting part 22, and a vibrator 23.

As shown in FIG. 2, the powder container 21 has an overall shape in which a part of a side wall of a cylinder is removed. One end of the cylinder is open and functions as a discharge part 211 for discharging powder when supplying the powder in the powder container 21 to the weighing pan 11. On the other hand, the other end of the cylinder is closed and functions as a bottom of the powder container 21 (supply-time bottom 212) when the cylinder is stood with the other end facing downward to accommodate powder P in the powder container 21. Note that, as described later, when the powder container 21 is mounted on the powder container mounting part 22, a portion other than the supply-time bottom 212 becomes the bottom of the powder container 21.

The range where the side wall of the cylinder is removed is a part on the discharge part 211 side in the longitudinal direction of the cylinder (for example, 1/3 to 3/4 of the total length of the cylinder), and is also a part in the circumferential direction (for example, 3/4 or less of the entire circumference), and the removed range increases toward the discharge part 211 side. The portion where the side wall of the cylinder is removed functions as a supply port 213 for the powder P when the powder is accommodated in the powder container 21. Further, a portion closer to the supply-time bottom 212 than the supply port 213, where the side wall of the cylinder is provided over the entire circumference, functions as a storage part 214 in which the powder P is stored when the powder P is accommodated in the powder container 21 with the cylinder standing.

Two concave container-side fixing parts 215, into which convex members described later are inserted when mounting the powder container 21 to the powder container mounting part 22, are provided spaced apart from each other in the longitudinal direction at locations positioned on the lower side when the longitudinal direction is oriented laterally such that the supply port 213 is on the upper side, among the side walls of the cylinder.

As the material of the powder container 21, a material having conductivity is used in the present embodiment. The entire powder container 21 may be formed of a conductive material such as metal made of stainless steel, aluminum, or the like, or a material in which a conductive film is formed on the surface of a non-conductive base material may be used.

The powder container mounting part 22 consists of two convex members provided so as to protrude from the upper surface of a housing 25 in which the vibrator 23 and the control unit 30 are accommodated and to be arranged in a lateral direction toward the weighing pan 11 of the electronic balance 10. It is preferable to use a conductive material for these members as well. These two convex members are arranged corresponding to the positions of the two container-side fixing parts 215 of the powder container 21, and the powder container 21 is mounted by inserting the members into the container-side fixing parts 215. Alternatively, two protrusions may be provided at the positions of the container-side fixing parts 215 so that the protrusions are inserted into the powder container mounting part 22. Furthermore, magnets may be provided in the container-side fixing parts 215 and the powder container mounting part 22 to fix them by magnetic force. In this way, while allowing the powder container 21 to be easily removed from the vibrator 23, the powder container 21 is prevented from coming off due to the vibration of the vibrator 23.

Regarding these two convex members, the one closer to the weighing pan 11 may be shorter than the one farther away. Due to such a difference in length between the two convex members, a mounting-time bottom 216, which becomes the bottom (lower side) of the powder container 21 in a state mounted on the powder container mounting part 22, is inclined so as to descend toward the discharge part 211, so that the powder easily proceeds to the discharge part 211. The inclination angle of the mounting-time bottom 216 at this time is determined to be a magnitude at which normal powder does not slide down due to static friction force between particles and the mounting-time bottom 216 and between particles in a state where vibration is not applied to the powder container 21. Alternatively, instead of the length of the convex members, each of the two container-side fixing parts 215 may be a protrusion, and by making the one closer to the weighing pan 11 shorter than the one farther away among the respective protrusions, the mounting-time bottom 216 may be inclined so as to descend toward the discharge part 211. On the other hand, when high-precision weighing is required, the powder can be made to approach the discharge part 211 slowly by making the two convex members substantially the same height and the two concave parts the same depth.

The vibrator 23 applies vibration to the two convex members serving as the powder container mounting part 22, thereby applying vibration to the powder container 21 via these convex members.

The control unit 30 acquires the weighing value signal from the measurement unit 12 of the electronic balance 10 and controls the operation of the vibrator 23 based on the weighing value. The control unit 30 is embodied by hardware such as a central processing unit (CPU) and software that causes the hardware to execute control.

In addition, although not shown, the weighing device 1 includes an input unit comprising buttons, a touch panel, or the like for an operator to perform input operations, and a display unit for displaying weighing values and the like.

Hereinafter, the operation of the weighing device 1 of the first embodiment will be described for a case where a predetermined amount of powder is weighed.

First, with the powder container 21 removed from the powder container mounting part 22, the operator accommodates the powder P to be weighed into the powder container 21 from the supply port 213. At that time, as shown in FIG. 2, by accommodating the powder P in the storage part 214, which is the portion of the powder container 21 where the cylindrical side wall is provided over the entire circumference, with the supply-time bottom 212 facing downward and the cylindrical powder container 21 standing, it is possible to prevent the powder P from spilling out of the supply port 213. The amount of the powder P accommodated in the powder container 21 is an amount expected to be sufficiently larger than the predetermined amount.

Instead of setting the powder container 21 in the standing state in this manner, as shown in FIG. 3, the powder P may be supplied from the supply port 213 onto the mounting-time bottom 216 with the mounting-time bottom 216 facing downward and the cylindrical powder container 21 laid down. In this case, the powder P may be supplied to a position directly below the supply port 213 together with the storage part 214 or instead of the storage part 214.

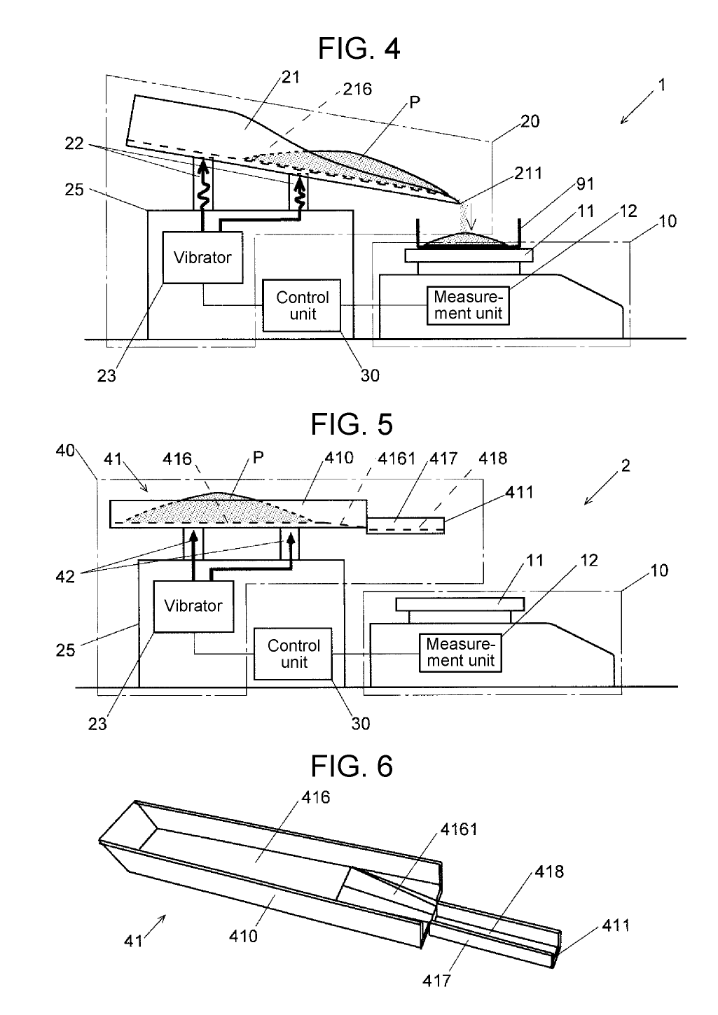

Next, the operator mounts the powder container 21 to the powder container mounting part 22 by inserting the convex portions of the powder container mounting part 22 into the two container-side fixing parts 215 of the powder container 21 to which the powder P has been supplied, respectively (FIG. 4). Here, if the one closer to the weighing pan 11 among the two convex portions of the powder container mounting part 22 is shorter than the one farther away, the powder container 21 is fixed in an inclined state such that the discharge part 211 is on the lower side. Even when the powder container 21 is fixed at an inclination in this manner, since the inclination angle of the mounting-time bottom 216 is determined to be a magnitude at which normal powder does not slide down due to static friction force between particles and the mounting-time bottom 216 and between particles as described above, the powder P in the powder container 21 does not slide down.

Further, the operator places a post-weighing powder container 91 for receiving the powder P to be weighed on the weighing pan 11 (FIG. 4). Note that weighing paper or the like may be placed on the weighing pan 11 instead of the post-weighing powder container 91.

The operation of mounting the powder container 21 to the powder container mounting part 22 and/or the operation of placing the post-weighing powder container 91 on the weighing pan 11 described so far may be performed automatically by providing a manipulator in the weighing device 1 instead of being performed by the operator.

Next, the operator sets a weighing weight value, which is the weight of the powder P to be weighed, by operating the operation unit. Subsequently, the operator performs a weighing start operation for starting weighing using the operation unit. Upon receiving this weighing start operation, the control unit 30 transmits a start signal, which is an electric signal, to the vibrator 23. Upon receiving the start signal, the vibrator 23 starts an operation of applying vibration to the powder container mounting part 22. Thereby, vibration is applied to the powder container 21 via the powder container mounting part 22. Then, the powder P in the powder container 21 receives the vibration and spreads in the longitudinal direction of the powder container 21, and also tries to move downward due to gravity, so it gradually moves toward the discharge part 211 which is the lower end in the longitudinal direction of the powder container 21. Then, the powder P that has reached the discharge part 211 gradually drops from the discharge part 211 to the weighing pan 11 and is accommodated in the post-weighing powder container 91 (FIG. 4).

As the powder P gradually drops onto the weighing pan 11 in this manner, the weighing value obtained by the measurement unit 12 gradually increases. The measurement unit 12 continuously transmits a weighing value signal indicating the obtained weighing value to the control unit 30. When the weighing value indicated by the weighing value signal reaches the weighing weight value set by the operator, the control unit 30 transmits a stop signal, which is an electric signal for stopping the application of vibration, to the vibrator 23. The vibrator 23 that has received the stop signal stops applying vibration to the powder container mounting part 22. Thereby, the vibration of the powder container 21 stops, and the powder P stops dropping from the discharge part 211, so the supply of the powder P to the post-weighing powder container 91 is also stopped. Through the above operations, the powder P of the weight set by the operator as the weighing weight value is weighed into the post-weighing powder container 91.

Here, if the powder P is charged with static electricity, the powder P may move in a clumped state. If this happens, it becomes difficult to drop the powder P gradually into the post-weighing powder container 91, the supply amount of the powder P to the post-weighing powder container 91 cannot be finely controlled, and precise weighing becomes impossible. However, in the present embodiment, by using a conductive material for the powder container 21, static electricity can be removed from the powder P, so it becomes possible to perform precise weighing while suppressing the influence of static electricity. Note that by using a conductive material for the powder container mounting part 22 together with the powder container 21, the static electricity of the powder P can be removed more reliably.

Note that control may be performed to weaken the intensity of the vibration applied by the vibrator 23 to the powder container mounting part 22 at a predetermined weighing value before reaching the weighing weight value. Further, such control for weakening the vibration may be performed in a plurality of stages so that the vibration becomes weaker in later stages.

As described above, when the next weighing is continuously performed with the same powder after one weighing is completed, the next weighing is executed by the same operation as the first weighing by the operator setting the weight value in the next weighing using the operation unit and then performing the weighing start operation while the powder container 21 remains mounted on the powder container mounting part 22.

On the other hand, when changing the type of powder to be weighed, or when it is necessary to avoid mixing powders of different manufacturing lots even if they are of the same type, the powder container 21 is removed from the powder container mounting part 22, the powder P remaining in the powder container 21 is recovered and removed, and then the inside of the powder container 21 is cleaned. The powder container 21 of the first embodiment can be easily cleaned because there are no places where powder is likely to clog, such as small holes, and there are no components that require disassembly during cleaning, such as valve members. After the cleaning of the powder container 21 is completed, by accommodating new powder P to be weighed in the powder container 21, an operation of weighing the new powder P to be weighed can be performed without mixing the powder P weighed so far.

Note that a plurality of powder containers 21 may be prepared in advance. This improves work efficiency because weighing can be executed using another powder container 21 while one powder container 21 is being used for weighing or being cleaned. Since the powder container 21 of the first embodiment does not require a complicated mechanism such as an on-off valve and is inexpensive, an increase in cost can be suppressed even if a plurality of them are prepared.

### Second Embodiment

FIG. 5 shows a weighing device 2 of a second embodiment. In this weighing device 2, the configurations of a powder container 41 and a powder container mounting part 42 of a powder supply device 40 are different from the configurations of the powder container 21 and the powder container mounting part 22 of the powder supply device 20 in the weighing device 1 of the first embodiment. Other components are the same as those in the weighing device 1 of the first embodiment, and thus description thereof is omitted. Hereinafter, the powder container 41 and the powder container mounting part 42 will be described in detail.

The powder container 41 has a configuration in which a main body trough part 410 and a discharge-side trough part 417 are connected in the longitudinal direction. As shown in FIGS. 5 and 6, the main body trough part 410 consists of a trough whose cross section perpendicular to the longitudinal direction is rectangular. The discharge-side trough part 417 is provided closer to the weighing pan 11 than the main body trough part 410 in a state mounted on the powder container mounting part 42, and the end portion on the weighing pan 11 side is a discharge part 411. The width of the discharge-side trough part 417 is narrower than that of the main body trough part 410. On the back surface of the main body trough part 410, container fixing concave parts (not shown) into which convex portions of the powder container mounting part 42 described later are inserted are provided. Most of a bottom surface 416 of the main body trough part 410 is substantially horizontal in a state mounted on the powder container mounting part 42, but a substantially trapezoidal powder convergence region 4161 near the discharge-side trough part 417 is formed so as to descend toward the discharge-side trough part 417. In the powder convergence region 4161, the shorter one of the upper base and lower base of the trapezoid matches the width and length of the discharge-side trough part 417 and is in contact with the end portion of the discharge-side trough part 417 opposite to the discharge part 411. The longer one of the upper base and lower base of the trapezoid matches the width and length of the main body trough part 410. A bottom surface 418 of the discharge-side trough part 417 is substantially horizontal in a state mounted on the powder container mounting part 42. As the material of the powder container 41, a material having conductivity is used as in the first embodiment.

The powder container mounting part 42 is similar to the powder container mounting part 22 in the first embodiment in that it consists of two convex members provided so as to be arranged in a lateral direction toward the weighing pan 11 of the electronic balance 10, but these two convex members have the same length as each other. Thus, when the powder container 41 is mounted on the powder container mounting part 42, the bottom surface 416 of the main body trough part 410 and the bottom surface 418 of the discharge-side trough part 417 become substantially horizontal.

The operation of the weighing device 2 of the second embodiment is basically similar to the operation of the weighing device 1 of the first embodiment, but the operation when accommodating the powder P in the powder container 41 and the behavior of the powder P when vibration is applied to the powder container 41 are different from the case of the first embodiment. Hereinafter, these differences will be described, and description of other operations will be omitted.

The powder P is accommodated on the bottom surface 416 of the main body trough part 410 in the powder container 41. In the second embodiment, it is not necessary to remove the powder container 41 from the powder container mounting part 42 except when cleaning the powder container 41, and the work of accommodating the powder P in the powder container 41 may be performed while the powder container 41 remains mounted on the powder container mounting part 42.

When vibration is applied from the vibrator 23 to the powder container 41 via the powder container mounting part 42, the powder P in the powder container 21 receives the vibration and gradually spreads in the longitudinal direction of the powder container 21, reaching the powder convergence region 4161. In the powder convergence region 4161, since the bottom surface descends toward the discharge part 211 (or the discharge-side trough part 417) and the width becomes narrower in the longitudinal direction, the powder P moves to the discharge-side trough part 417 while narrowing (converging) the distribution width. The powder P reaching the discharge-side trough part 417 receives the vibration of the powder container 41 (discharge-side trough part 417 therein) and gradually moves toward the discharge part 211, and drops from the discharge part 211 onto the weighing pan 11.

The weighing device 2 of the second embodiment exhibits the same effects as the weighing device 1 of the first embodiment. In addition, in the weighing device of the second embodiment, since the powder P is accommodated in the main body trough part 410 wider than the discharge-side trough part 417 and then supplied to the weighing pan 11 through the discharge-side trough part 417 while converging in the width direction in the powder convergence region 4161, it is possible to weigh the powder P onto the narrow weighing pan 11 while accommodating a large amount of the powder P.

### Third Embodiment

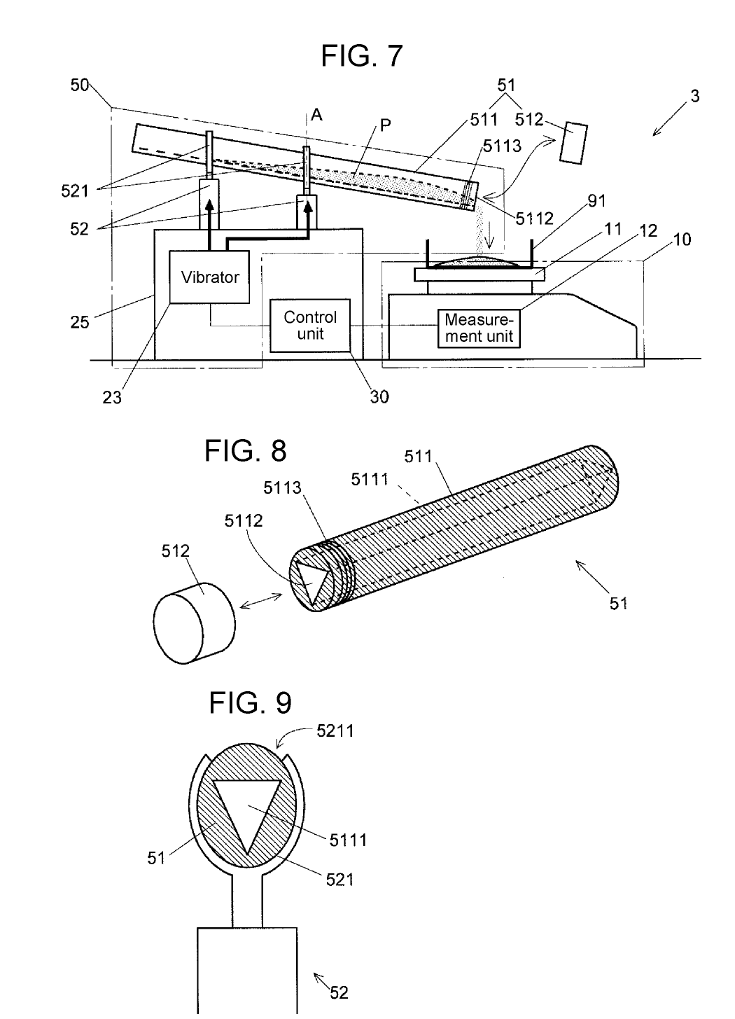

FIG. 7 shows a weighing device 3 of a third embodiment. In this weighing device 3, the configurations of a powder container 51 and a powder container mounting part 52 of a powder supply device 50 are different from the configurations of the powder container 21 and the powder container mounting part 22 of the powder supply device 20 in the weighing device 1 of the first embodiment and the configurations of the powder container 41 and the powder container mounting part 42 of the powder supply device 40 in the weighing device 2 of the second embodiment. Other components are the same as those in the weighing devices 1 and 2 of the first and second embodiments, and thus description thereof is omitted. Hereinafter, the powder container 51 and the powder container mounting part 52 will be described in detail.

As shown in FIGS. 7 and 8, the powder container 51 has a container body 511 and a lid 512. The container body 511 is made of metal which is a conductive material and has a cylindrical shape. A triangular prism-shaped powder accommodation space 5111 is provided in the container body 511. In the present embodiment, the triangular prism is a regular triangular prism whose bottom surface is a regular triangle, but it may be a triangular prism whose bottom surface has an isosceles triangle or other triangular shapes. Besides that, it is not limited to a triangle, such as a circle or an ellipse. One end of the powder accommodation space 5111 is an opening 5112, and the other end is closed. This opening serves as a supply port when supplying the powder P to the powder accommodation space 5111 and also serves as a discharge part when discharging the powder P from the powder accommodation space 5111. The lid 512 is attached to the opening 5112 side of the container body 511. In the present embodiment, the lid 512 is attached to the container body 511 by screwing a female screw (not shown) provided on the inner surface of the lid 512 and a male screw 5113 provided on the outer surface of the container body 511, but the lid 512 may be attached to the container body 511 using other configurations. When the lid 512 is attached to the container body 511, the powder accommodation space 5111 is sealed. The outer shape of the container body 511 is cylindrical, but may be other shapes such as a triangular prism.

FIG. 9 shows the configuration of the powder container mounting part 52 in a substantially vertical cross section A shown in FIG. 7. In the cross section A, the powder container 51 exhibits a vertically long elliptical shape. The powder container mounting part 52 has a gripping part 521 formed by providing a notch 5211 at the top of an annular body exhibiting a vertically long elliptical shape. The powder container 51 is inserted into the annular body from the notch 5211. The gripping part 521 is made of metal which is a material having conductivity and flexibility. By having flexibility in this way, the gripping part 521 spreads to both sides when the powder container 51 is inserted, and acts to clamp the powder container 51 from both sides in a state where the powder container 51 is inserted to a predetermined position. Two powder container mounting parts 52 are provided so as to be arranged in a lateral direction toward the weighing pan 11 of the electronic balance 10. Among the gripping parts 521 respectively included in these two powder container mounting parts 52, the one located closer to the weighing pan 11 is provided at a lower position than the other one.

The operation of the weighing device 3 of the third embodiment is basically similar to the operation of the weighing device 1 of the first embodiment, but the operations when accommodating the powder P in the powder container 51 and when mounting the powder container 51 to the powder container mounting part 52 are different from the case of the first embodiment. Hereinafter, these differences will be described, and description of other operations will be omitted.

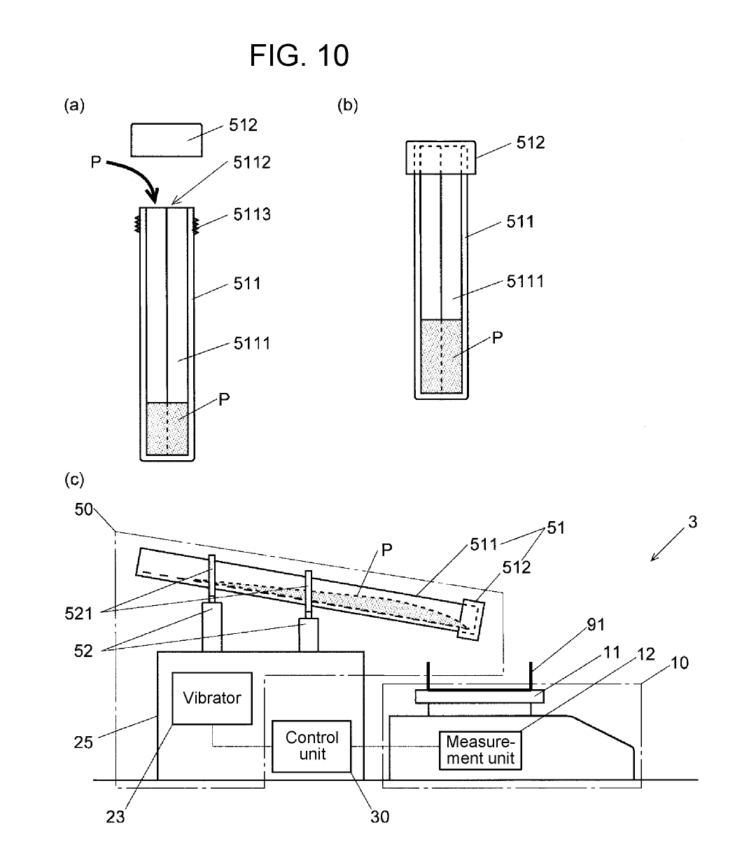

First, with the powder container 51 removed from the powder container mounting part 52, the operator accommodates the powder P into the powder accommodation space 5111 from the opening 5112 (FIG. 10(a)), and attaches the lid 512 to the opening 5112 (FIG. 10(b)). The powder container 51 is placed in a predetermined place with the lid 512 attached.

Next, with the lid 512 attached, the powder container 51 is mounted by inserting it into the gripping parts 521 of the two powder container mounting parts 52 from the notches 5211 respectively (FIG. 10(c)). Here, the powder container 51 is mounted on the powder container mounting part 52 in a state where the opening 5112 side is directed toward the weighing pan 11 side in the longitudinal direction and one side among the side sides (sides perpendicular to the triangular bottom surface) of the triangular prism-shaped powder accommodation space 5111 is directed downward in the circumferential direction. Therefore, in the cross section shown in FIG. 9, one of the vertices of the triangle of the powder accommodation space 5111 faces downward. Further, since the gripping part 521 located closer to the weighing pan 11 is provided at a lower position than the other one as described above, the mounted powder container 51 is mounted in a state inclined from the horizontal with the opening 5112 side facing downward.

Thereafter, immediately before starting the operation of supplying the powder P to the weighing pan 11, the lid 512 is removed from the powder container body 511.

Note that part or all of the operations up to this point may be performed automatically by providing a manipulator in the weighing device 3 instead of being performed by the operator.

Next, vibration is applied from the vibrator 23 to the powder container 51 via the powder container mounting part 52. Thereby, the powder P in the powder container 51 receives the vibration and gradually moves toward the opening 5112 side directed downward as described above, drops little by little from the opening (discharge part) 5112, and is supplied to the post-weighing powder container 91 on the weighing pan 11. Subsequent operations are the same as those of the weighing device 1 of the first embodiment.

If the powder P absorbs moisture, the mass including the powder P and the moisture is weighed, so the powder P cannot be weighed accurately. At the same time, the powder P clumps together, making it impossible to supply the powder P little by little from the powder container 51, and the supply amount of the powder to the post-weighing powder container 91 cannot be finely controlled, making precise weighing impossible. In contrast, in the weighing device 3 of the third embodiment, by attaching the lid 512 to the opening during the period from accommodating the powder P in the powder accommodation space 5111 to starting the supply to the post-weighing powder container 91, it is possible to prevent the powder P from absorbing moisture in the air during that time, so the powder P can be weighed accurately and precisely.

In the above description, the powder container 51 was mounted on the gripping part 521 with the lid 512 attached, but it may be mounted on the gripping part 521 after removing the lid 512. By removing the lid 512 before the powder container 51 is mounted on the gripping part 512 (sic, 521), it becomes easy to remove the lid 512.

Further, the weighing device 3 of the third embodiment can also perform precise weighing by preventing the powder P from clumping in that static electricity can be removed from the powder P by using a material having conductivity for the material of the powder container 51 similarly to the first embodiment.

Furthermore, in the weighing device 3 of the third embodiment, the powder accommodation space 5111 exhibits a groove-like shape having a V-shaped cross section by mounting the powder container 51 to the powder container mounting part 52 in a state where one of the side sides of the triangular prism-shaped powder accommodation space 5111 faces downward. By having such a shaped powder accommodation space 5111, the powder P can be smoothly sent out to the opening (discharge part) 5112 along the groove.

### Modifications

The present invention is not limited to the above three embodiments, and various modifications are possible. For example, in the first embodiment, the powder container 21 having a shape in which a part of the cylindrical side wall is removed is used, but a cylindrical powder container in which the side wall is not removed or a trough-shaped powder container in which a part of the side wall in the circumferential direction is removed over the entire length of the cylinder may be used. Further, instead of a cylinder, a tube whose cross section is a polygon such as a quadrangle (including a rectangle and a square) or a triangle may be used. The supply-time bottom 212 may be omitted.

In the first embodiment, the powder container 21 is mounted on the powder container mounting part 22 while being inclined so that the discharge part 211 is on the lower side, and in the second embodiment, the powder container 41 is mounted on the powder container mounting part 22 while being substantially horizontal. However, the powder container 21 of the first embodiment may be mounted on the powder container mounting part 42 of the second embodiment while being substantially horizontal, or the powder container 41 of the second embodiment may be mounted on the powder container mounting part 22 of the first embodiment while being inclined so that the discharge part 411 is on the lower side.

In each of the above embodiments, a material having conductivity is used as the material of the powder container, but a case where a material not having conductivity such as plastic is used is also included in the present invention.

In addition, the components of the above three embodiments and modifications may be combined and used as appropriate.

### Aspects

It is apparent to those skilled in the art that the exemplary embodiments described above are specific examples of the following aspects.

(Item 1) A weighing device according to one aspect of the present invention comprises:

an electronic balance having a weighing pan;

a trough-shaped or tubular powder container having a discharge part at one end;

a powder container mounting part capable of detachably mounting the powder container such that the discharge part is positioned directly above the weighing pan;

a vibrator mounted on the powder container mounting part for applying vibration to the discharge part of the powder container; and

a control unit that acquires a weighing value from the electronic balance and controls an operation of the vibrator based on the weighing value.

In the weighing device according to Item 1, when changing the type or manufacturing lot of the powder to be weighed, the powder container is removed from the vibrator, and the inside of the powder container is cleaned. At that time, since the powder container is tubular or trough-shaped and one end of the tube or trough is the discharge part, there is no need to clean a narrow space such as a small hole. Further, since it is not necessary to provide a valve for opening and closing the discharge part, there is no need for the effort of removing the valve before cleaning or attaching the valve after cleaning. For the above reasons, the effort of cleaning can be suppressed by the weighing device according to Item 1.

(Item 2) The weighing device according to Item 2is the weighing device according to Item 1, wherein

a container-side fixing part for fixing to the powder container mounting part is provided in the powder container, and

the powder container mounting part is provided at a position corresponding to the container-side fixing part of the vibrator.

According to the weighing device according to Item 2, the powder container can be easily mounted on the powder container mounting part.

(Item 3) The weighing device according to Item 3 is the weighing device according to Item 1 or 2, wherein the other end of the powder container is closed.

The other end of the powder container closed in this way can function as the bottom of the powder container when accommodating powder in a state where the powder container stands with the other end facing downward.

(Item 4) The weighing device according to Item 4 is the weighing device according to any one of Items 1 to 3, wherein a powder convergence region where the bottom surface descends toward the discharge part and the width becomes narrower in a state where the powder container is mounted on the powder container mounting part is provided on the bottom surface of the powder container.

According to the weighing device according to Item 4, since the powder moves toward the discharge part so that the width in which the powder is distributed becomes narrower in the powder convergence region, it is possible to supply the powder into a narrow region on the weighing pan while accommodating a large amount of powder in a wider range in the powder container.

(Item 5) The weighing device according to Item 5 is the weighing device according to any one of Items 1 to 4, wherein a space inside the powder container has a groove-like shape with a V-shaped cross section.

According to the weighing device according to Item 5, since the space inside the powder container has a groove-like shape with a V-shaped cross section, the powder can be smoothly sent out to the discharge part along the groove.

(Item 6) The weighing device according to Item 6 is the weighing device according to any one of Items 1 to 5, wherein the powder container is made of a material having conductivity.

According to the weighing device according to Item 6, since the powder container is made of a material having conductivity, static electricity can be removed from the powder accommodated in the powder container. This prevents the powder P from moving in a state of being charged with static electricity and clumping, and allows the powder to be gradually discharged from the discharge part, so that the supply amount of the powder can be finely controlled and precise weighing can be performed.

(Item 7) The weighing device according to Item 7 is the weighing device according to any one of Items 1 to 6, wherein the powder container includes a lid attached to the discharge part.

If the powder in the powder container absorbs moisture, the mass including the powder and the moisture is weighed, so the powder cannot be weighed accurately. Also, the powder clumps together, making it impossible to supply the powder little by little from the powder container, and the supply amount of the powder cannot be finely controlled, making precise weighing impossible. In contrast, in the weighing device according to Item 7, by attaching the lid to the discharge part after accommodating the powder in the powder container and removing the lid immediately before supplying the powder from the discharge part, it is possible to suppress the powder P from absorbing moisture in the air. Therefore, the powder can be weighed with accurate and precise accuracy.

### EXPLANATION OF REFERENCE SIGNS

1, 2, 3...Weighing device

10...Electronic balance

11...Weighing pan

12...Measurement unit

20, 40, 50...Powder supply device

21, 41, 51...Powder container

211, 511...Discharge part

212...Supply-time bottom

213...Supply port

214...Storage part

215...Container-side fixing part

216...Mounting-time bottom

22, 42, 52...Powder container mounting part

23...Vibrator

25...Housing

30...Control unit

410...Main body trough part

416...Bottom surface of main body trough part

4161...Powder convergence region

417...Discharge-side trough part

418...Bottom surface of discharge-side trough part

5111...Powder accommodation space

5112...Opening (Supply port, Discharge part)

5113...Male screw

512...Lid

521...Gripping part

5211...Notch

91...Post-weighing powder container

P...Powder

1. A weighing device comprising:
an electronic balance having a weighing pan;
a trough-shaped or tubular powder container having a discharge part at one end;
a powder container mounting part capable of detachably mounting the powder container such that the discharge part is positioned directly above the weighing pan;
a vibrator mounted on the powder container mounting part for applying vibration to the discharge part of the powder container; and
a control unit that acquires a weighing value from the electronic balance and controls an operation of the vibrator based on the weighing value.

2. The weighing device according to claim 1, wherein
a container-side fixing part for fixing to the powder container mounting part is provided in the powder container, and
the powder container mounting part is provided at a position corresponding to the container-side fixing part of the vibrator.

3. The weighing device according to claim 1, wherein the other end of the powder container is closed.

4. The weighing device according to claim 1, wherein a powder convergence region where the bottom surface descends toward the discharge part and the width becomes narrower in a state where the powder container is mounted on the powder container mounting part is provided on the bottom surface of the powder container.

5. The weighing device according to claim 1, wherein a space inside the powder container has a groove-like shape with a V-shaped cross section.

6. The weighing device according to claim 1, wherein the powder container is made of a material having conductivity.

7. The weighing device according to claim 1, wherein the powder container includes a lid attached to the discharge part.
